(19) United States
(12) Patent Application Publication
(10) Pub. No.: US 2016/0014587 A1
(43) Pub. Date: Jan. 14, 2016

(54) WEB SERVER FOR EMERGENCY SERVICES CALL

(71) Applicant: GORDON JOHN HINES, Kirkland, WA (US)

(72) Inventor: GORDON JOHN HINES, Kirkland, WA (US)

(73) Assignee: TELECOMMUNICATION SYSTEMS, INC., Annapolis, MD (US)

(21) Appl. No.: 14/858,915

(22) Filed: Sep. 18, 2015

Related U.S. Application Data
(63) Continuation-in-part of application No. 14/219,667, filed on Mar. 19, 2014.
Application No. 14/219,667 is a continuation-in-part of application No. 13/317,783, filed on Oct. 28, 2011, now Pat. No. 8,681,946.
Application No. 13/317,783 is a continuation-in-part of application No. 11/705,101, filed on Feb. 12, 2007, now Pat. No. 8,050,386.
(60) Provisional application No. 62/115,535, filed on Feb. 12, 2015.

(51) Int. Cl. H04W 4/22; H04W 4/02

(52) U.S. Cl. CPC H04W 4/22; H04W 4/02

(57) ABSTRACT

A web server, the web server can be configured to receive a request for a web page in a standard web protocol from a web browser operating at a third party emergency call service via a network. The web server can also be configured to receive a locator key corresponding to an emergency services call from an end-user device employed to initiate an emergency services call. The emergency services call is initially routed to a Public Safety Answering Point (PSAP). The web server can further be configured to provide a location request in a protocol compatible with an Automatic Locator Identifier (ALI) service via the network. The web server can still further be configured to convert location information for the end-user device provided from the ALI service in response to the location request into a standard web protocol.

### CROSS-REFERENCE TO RELATED APPLICATION

This application claims the benefit of priority to U.S. Provisional Application No. 62/115,535, filed on 12 Feb. 2015, and entitled SYSTEMS AND METHODS FOR PROVIDING ANCILLARY EMERGENCY INFORMATION TO A SECONDARY CALL CENTER, the entirety of which is herein incorporated by reference, this application is also a continuation-in-part of U.S. patent application Ser. No. 14/219,667 entitled MOBILE AUTOMATIC LOCATION IDENTIFICATION (ALI) FOR FIRST RESPONDERS, filed on 19 Mar. 2014, which is a continuation application of U.S. patent application Ser. No. 13/317,783, filed on 28 Oct. 2011, which issued as U.S. Pat. No. 8,681,946 on 25 Mar. 2014, which is a continuation application of U.S. patent application Ser. No. 11/705,101, which was filed on 12 Feb. 2007 and issued as U.S. Pat. No. 8,050,386 on 1 Nov. 2011, the entirety of each is herein incorporated herein by reference.

### TECHNICAL FIELD

This disclosure relates to emergency call systems (e.g., E9-1-1), including wireless and Internet Protocol (IP) based Voice Over Internet Protocol (VoIP) emergency call systems, that rely on non-call associated signaling in order to provide location data.

### BACKGROUND

9-1-1 is a phone number widely recognized in North America as an emergency phone number that is used to contact emergency dispatch personnel. Enhanced 9-1-1 (E9-1-1) is defined by an emergency services call being selectively routed to an appropriate Public Service Answering POINT (PSAP), based on an identifier, such as Pseudo Automatic Number Identifier (pANI), which can also be referred to as an ESxK. The identifier can include the transmission of callback number and location information when 9-1-1 is used. E9-1-1 may be implemented for wireless (e.g., cellular) landline, or VoIP networks.

Regardless of the network type, a 9-1-1 service becomes E-9-1-1 when automatic number identification and automatic location information related to the call is provided to the 9-1-1 operator at the PSAP. A primary challenge results from the fact that calls may arrive at the PSAP without the caller's actual callback number or location information displayed at the emergency operator's terminal.

FIG. 3 shows a conventional landline public safety access point (PSAP) to automatic location identifier (ALI) connection.

In particular, FIG. 3 shows a PSAP 400 connected to one Automatic Location Identifier (ALI) database 401. Upon receiving a 9-1-1 call, the PSAP 400 queries the ALI 401 for location data. The ALI database 401 accepts the query from the PSAP 400 for location. The query includes the telephone number of an emergency caller. The ALI database 401 relates the received telephone number to a physical street address and provides that street address (location information) back to the PSAP 400 in a manner that works for the customer premise equipment (CPE) display at the PSAP 400.

An ALI is typically owned by a local exchange carrier (LEC) or a PSAP, and may be regional (e.g., connected to many PSAPs) or standalone (e.g., connected to only one PSAP). There is currently no one single standard interface protocol for PSAP-ALI connection/communication.

FIG. 4 shows a context diagram for a conventional non-landline positioning center (e.g., an Internet based voice over Internet Protocol (VoIP) positioning center).

In particular, the ALI database 401a includes a conventional emergency services key (ESQK or ESRK) (a locator key) in a location request sent to an appropriate positioning center 402 (xPC). The emergency services key (ESQK or ESRK) is used by the positioning center 402 as a key to look up the location and other call information associated with the emergency services call.

In non-landline telephony, the PSAPs 400a query the ALI 401 a for location information. However, the ALI 401 a is not pre-provisioned with location data for non-landline calls (e.g. cellular, VoIP etc.) and must communicate with other network entities to obtain and deliver location data to the PSAP 400. Non-landline telephony standards (e.g. cellular, VoIP etc) have mandated that ALIs 401a maintain connectivity to a positioning center 402 that is able to provide current location data for a non-landline call. In the current state of technology, the positioning center 402 provides the caller's location and the callback number to the ALI 401a, which passes it to the requesting PSAP. As can be seen in FIG. 4, an ALI may maintain connectivity to more than one positioning center via multiple interface types—both standard and non-standard (e.g. NENA-02, E2/E2+/V-E2(ESP), PAM, etc.).

As used herein, the generic term “xPC” refers interchangeably to any standards-based positioning center. As examples, a positioning center 402 may be any one of the following types used in non-landline networks:
GMLC (Gateway Mobile Location Center): The positioning center that retrieves, forwards, stores and controls emergency position data within the GSM location network.
MPC (Mobile Position Center): The positioning center that retrieves, forwards, stores and controls emergency position data within the ANSI location network.
VPC (VoIP Positioning Center): The positioning center which retrieves, forwards, stores and controls emergency position data within the VoIP location network.

The term “xPC network” is used herein when appropriate to refer to any non-landline network where a positioning center 402 responds to ALI queries including an emergency services key for location, e.g., cellular, VoIP etc.

In the process of handling an emergency services call, a first responder (or responders) may be dispatched to the caller's location. Typically, the dispatcher at the Public Safety Answering Points (PSAPs) determines the appropriate first responder(s), and makes contact with a dispatcher for the appropriate first responder. After contact, the PSAP dispatcher (and/or the dispatcher for the first responder) conveys relevant location information to the first responder.

Using conventional techniques, most PSAPs rely on the age-old method of verbally relaying caller Automatic Location Identification (ALI) data to the first responder, e.g., speaking the caller's location information over a voice phone call between the PSAP and the first responder.

While many police and fire department vehicles do have wireless data transfer capabilities, such services are typically used to interact with local or regional databases to check license plates, criminal records, outstanding warrants, etc. No conventional method exists to use wireless data transfer capabilities for downloading ALI data relating to a PSAP's emergency services call to a first responder.

Needless to say, while serving the purpose, verbal relay of location information is slow and prone to error. At best, verbal transfer of ALI information from a PSAP to a first responder delays a lifesaving response, and at worst can result in the dispatch of a first responder to a wrong address.

There is a long felt but unsolved need for efficient transfer of location information relating to a PSAP's emergency services call from the PSAP to a first responder.

### SUMMARY

One example relates to a non-transitory machine readable medium having machine executable instructions comprising a web server. The web server can be configured to receive a request for a web page in a standard web protocol from a web browser operating at a third party emergency call service via a network. The web server can also be configured to receive a locator key corresponding to an emergency services call from an end-user device employed to initiate an emergency services call. The emergency services call can be initially routed to a Public Safety Answering Point (PSAP). The web server can further be configured to provide a location request in a protocol compatible with an Automatic Locator Identifier (ALI) service via the network. The web server can still further be configured to convert location information for the end-user device provided from the ALI service in response to the location request into a standard web protocol.

Another example relates to a web server that can include a non-transitory memory to store machine readable instructions and a processing unit to access the memory and execute the machine readable instructions. The machine readable instructions can include a web application server configured to provide a web interface to a web browser via a standard web protocol. The web browser can operate at a third party emergency call service. The web application server can also be configured to receive a locator key for an emergency services call initiated at an end-user device via the standard web protocol and generate a location request that includes the locator key. The machine readable instructions can also include a location request engine configured to convert the location request into a protocol employable by an ALI service to form a converted location request. The location request engine can further be configured to provide the converted location request to the ALI service and to convert location information received from the ALI service into a web format.

Yet another example relates to a method that can include receiving, from a user terminal operating at a third party emergency service call center, a locator key corresponding to an emergency services call routed to a PSAP, wherein the emergency services call has been transferred to the third party emergency service call center. The method can also include converting a location request from a standard web format into a protocol employable by an ALI service. The method can further include converting a response to the location request into the standard web format.

### BRIEF DESCRIPTION OF THE DRAWINGS

FIG. 1 illustrates an example of relevant network elements in an E911 mobile ALI system that provides ALI data digitally from a PSAP to a first responder or other entity.

FIG. 2 illustrates an example of a mobile ALI call flow tracing a 911 call using an E911 mobile ALI system such as that shown in FIG. 1.

FIG. 3 an example of a conventional landline public safety access point (PSAP) to automatic location identifier (ALI) connection.

FIG. 4 illustrates a context diagram for an example of a conventional non-landline positioning center (e.g., an Internet based voice over Internet Protocol (VoIP) positioning center).

FIG. 5 illustrates an example of a system for processing an emergency services call that is transferred to a third party emergency call service.

FIG. 6 illustrates an example of a web server for providing web data corresponding to an emergency services call that is transferred to a third party emergency call service.

FIG. 7 illustrates a flowchart of an example method for providing web data for an emergency services call that is transferred to a third party emergency call service.

### DETAILED DESCRIPTION

The present examples facilitate the transfer of Automatic Location Indication (ALI) data digitally from a Public Safety Answering Point (PSAP) to a first responder or other entity, such as a third party emergency call center.

In particular, the examples described herein provide a web site accessible to first responders or other users, such as users at the third party emergency call center that lists each live E911 call (e.g., an emergency services call) within their jurisdiction, and appends the caller's ALI data relative to each call. The first responders or other users at the third party emergency call center (e.g., security desk personnel, police car, paramedic, ambulance, fire truck, etc.) can view not only the emergency caller's information for those E911 calls that they are responding to, but they can also view information about other emergency callers. This facilitates the actual response to individual emergency calls as well as the overall management of multiple responders to multiple emergency services calls.

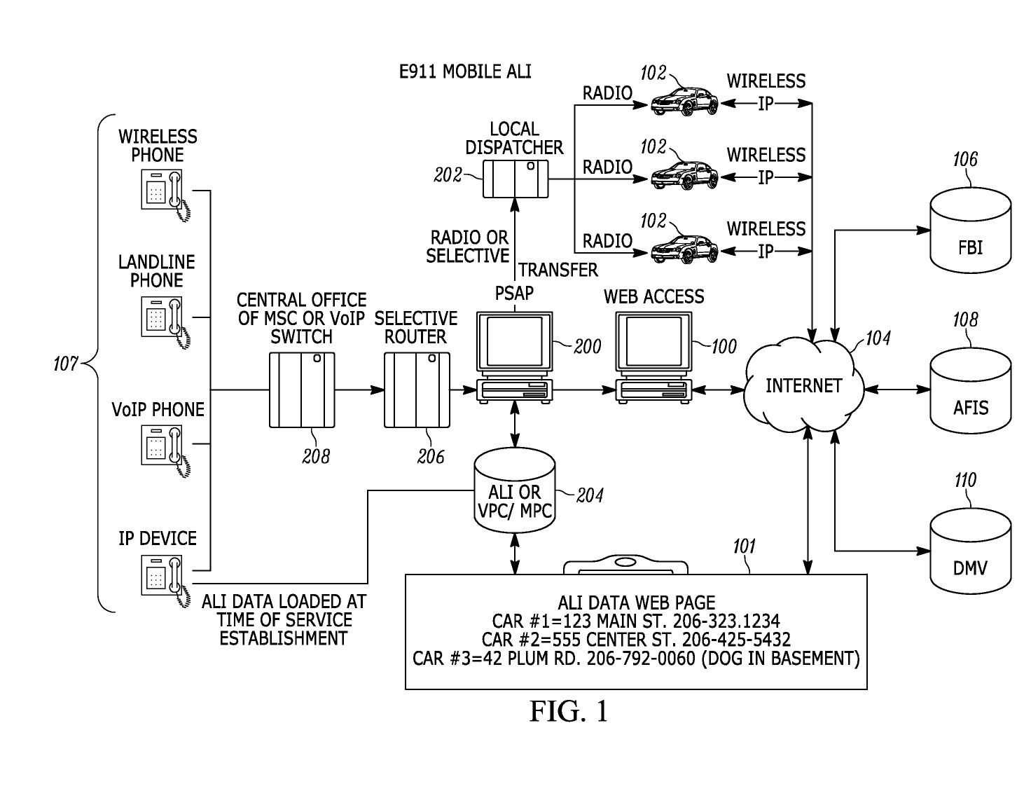

FIG. 1 shows relevant network elements in an E911 mobile ALI system that provides ALI data digitally from a PSAP to a first responder or other user/entity.

In particular, as shown in FIG. 1, an emergency services call may be initiated from any type of phone device 107, e.g., a wireless phone, a landline phone, a voice over Internet Protocol (VoIP) phone, an Internet Protocol (IP) device, etc.

The emergency services call is handled by a relevant central office 208 (landline phone), mobile switching center (wireless phone), or VoIP switch (VoIP phone), and routed to an appropriate public safety answering point (PSAP) 200, e.g., via a selective router 206. Automatic location identification (ALI) location data is obtained for an appropriate ALI, VoIP positioning center (VPC), or mobile positioning center (MPC) 204.

In some examples, the local dispatcher 202 at the PSAP 200 determines what first responder(s) are appropriate for the given emergency services call, and dispatches the appropriate first responder vehicle 102.

The first responder vehicles 102 are provided with Internet Protocol (IP) based wireless access capability via the public Internet 104, and a suitable web browser capable of accessing an ALI data web page 101.

Moreover, an Internet accessible ALI data web page 101 is hosted by the xPC, with individual ALI data displayed and correlated by ESxK. The PSAP 200 and/or local dispatcher 202 maintain real-time updates (e.g., within about 10 seconds) via a web access 100 by adding the identity of the dispatched unit to the ALI display. The web page is accessible by, and the first responder has access to, the Internet (e.g., via an Internet browser).

The ALI data web page 101 is capable of displaying location information relating to a current or recent emergency E911 call. ALI information displayed on the ALI data web page 101 may be maintained for a given length of time after a given emergency services call terminates, based on an amount of memory available in a host server. If an indefinite amount of memory is available, the ALI information displayed on the ALI data web page 101 may correspondingly be available for an indefinite length of time. In any event, the ALI data web page 101 can provide first responders with active or very recent emergency services call location information to arrive quickly to render aid to the emergency caller.

As shown in FIG. 1, government agencies such as the Federal Bureau of Investigation (FBI) 106, the relevant Department of Motor Vehicles (DMV) 110, the Automated Fingerprint Identification System (AFIS) 108, etc. may also view the ALI location data posted at the ALI data web page 101. Additionally, the responders may view databases maintained by these agencies via the same internet connection using existing access protocols. Similarly, other users/entities, such as a third party emergency call service can additionally or alternatively be included. In some examples described herein, the emergency services call can be transferred to the FBI 106, the DMV 110, the AFIS 108 or the third party emergency call service.

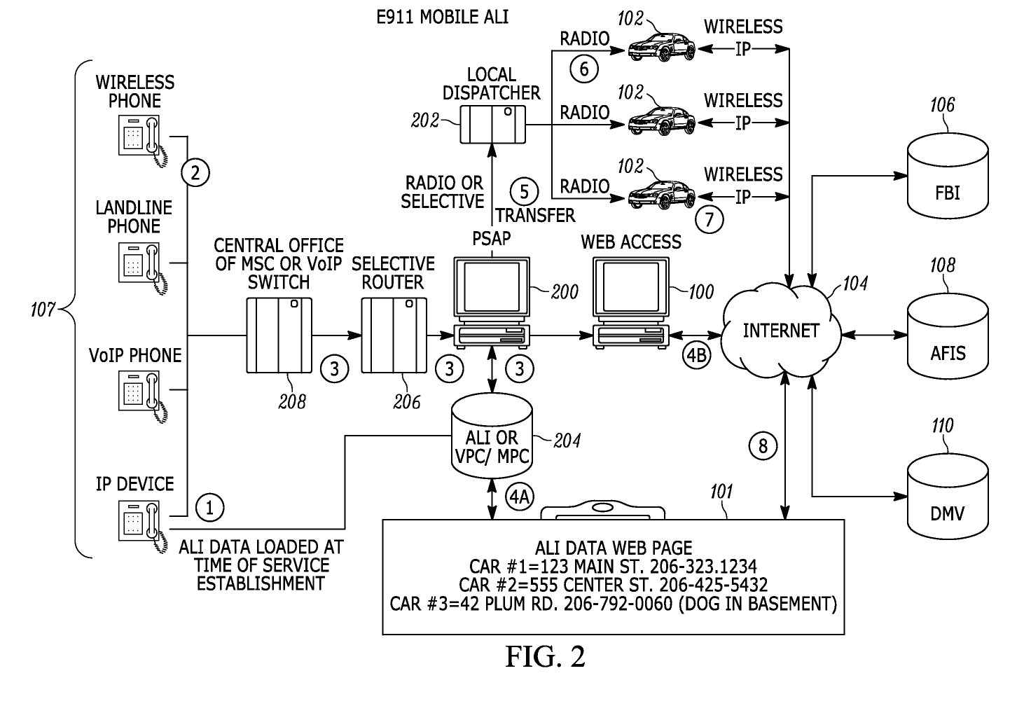

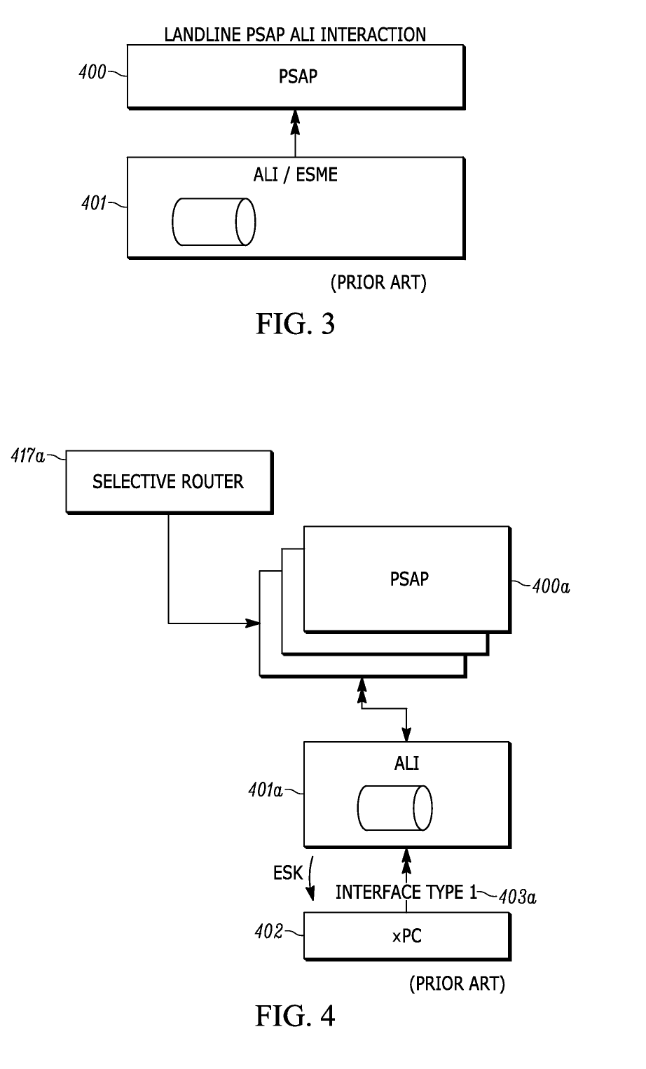

FIG. 2 shows an exemplary mobile ALI call flow tracing a 911 call using an E911 mobile ALI system such as that shown in FIG. 1.

In particular, as shown in step 1 of FIG. 2, at the time of service establishment (or other appropriate time), a caller's ALI data is uploaded into an appropriate database (i.e., the ALI database). Typically, this will be an ALI database managed by the PSAP or the LEC or an MPCNPC. Additional data can be loaded by the customer above and beyond the traditional ALI data. For example, the customer might wish to alert responders that they have pets (in case of fire), or that they are allergic to morphine, etc.

In step 2, the emergency caller dials 911 from any device, e.g., wireless, landline, voice over Internet protocol (VoIP), etc.

In step 3, the emergency services call is directed to the PSAP via traditional methods. That is, the emergency services call is routed to the PSAP via existing technology or via next generation Internet Protocol (IP). The PSAP queries the ALI database via existing or future IP technology, and receives ALI data via traditional methods, and retrieves ALI data.

In step 4a, the xPC stages data in a hosted web page that relates the ESxK with the ALI data for that call.

In step 4b, the PSAP dispatcher accesses the hosted ALI web site for additional ALI information data. The PSAP dispatcher also annotates the web site with responder assignment. Thus, the ALI data web page 101 is hosted by the VPC/MPC 204, and the initial ALI data and ESxK information is posted by the VPC/MPC 204 (step 4a). In the disclosed embodiments, the dispatcher merely adds the dispatched vehicle information in step 4b.

Thus, using the caller's telephone number, the PSAP queries a separate web site for additional ALI data. Via this web site, the PSAP dispatcher enters the responder info that identifies which responder was assigned to this call. In some cases, this responder might be a local police precinct, for example. The dispatcher at the precinct can log into the web site and add information as to which specific patrol car was dispatched to the scene. The dispatcher at the PSAP or at the precinct can also view what other patrol cars have been dispatched to other emergencies.

In step 5, the PSAP dispatcher relays caller information data to the local first responder (or other entity, such as a third party emergency call center), or dispatches responders directly via radio.

Thus, the local responder (or other user) receives the verbal dispatch and logs onto the web site. The responder (or other user) can input his/her own ID and can then view information related to calls that have been dispatched to him/her. The responders can also view what fellow responders (or other users) have been dispatched to other emergencies.

In step 6, if related to an intermediate dispatcher, the intermediate dispatcher accesses the web site and updates the ultimate responder information. The responder (or other user) can add additional data to the web site related to the status of the response.

In step 7, when the responder (or other user) receives the radio call and/or a transferred emergency services call, they log into the web site.

In step 8, the web site displays all data related to the emergency services call, plus data for other emergency services calls.

Benefits of the examples described can include, aside from facilitating individual emergency responses and overall emergency management, the responders' (or other users') management can use this web site to download daily summary reports.

The examples described herein can be employed with any public safety entity involved in emergency response, particularly those related to E911.

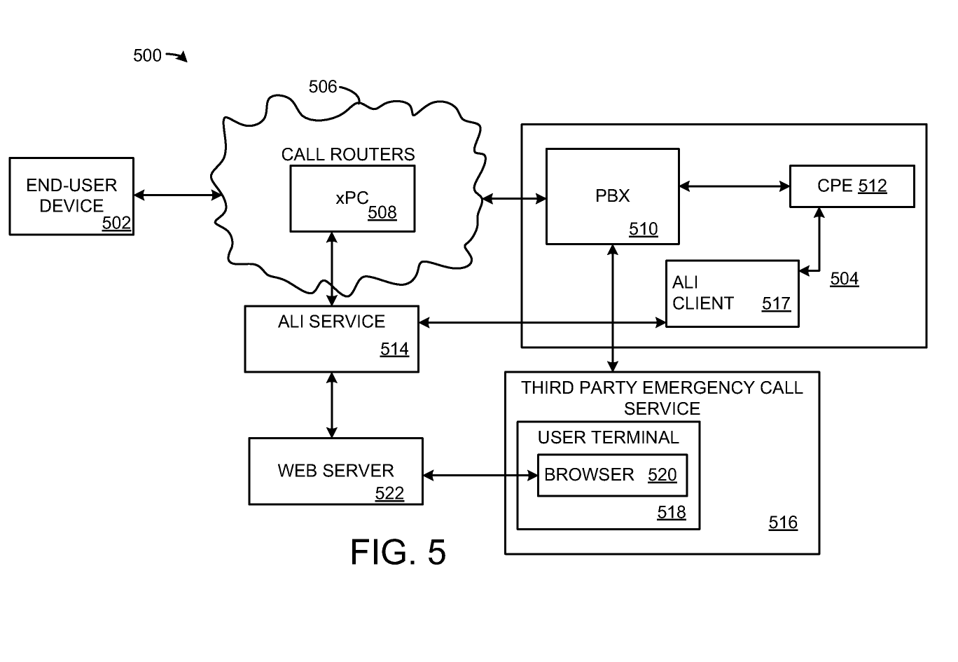

FIG. 5 illustrates an example of a system 500 configured to facilitate the transferring of emergency services calls to a secondary call center or other user such as a first responder. The system 500 can include an end-user device 502 operated by an end-user. The end-user device 502 can be a mobile device, such as a wireless phone (e.g., a smart phone, a feature phone, etc.). In some examples, the end-user device 502 can be a Voice over Internet Protocol (VoIP) phone. In some examples, the end-user device 502 can be employed to implement the phone device 107 of FIG. 1.

The end-user device 502 can be employed by the end-user to initiate an emergency services call. The emergency services call can be, for example, a voice 9-1-1 call (an E911 call), a 9-1-1 text (or short) message (e.g., a short message service (SMS) message), etc. The emergency services call can be a request for immediate emergency assistance, including ambulatory service, police assistance, fire department assistance, assistance on waterways, etc.

The emergency services call can be routed to a PSAP 504 via call routers 506 in a manner described herein. The call routers 506 can be representative of a collection of telephony routers, including, but not limited to a cell tower, a mobile switching center (MSC), selective routers, etc. For instance, the call routers 506 can be configured to include the relevant central office 208 and selective router 206 of FIG. 1. The call routers 506 can also include an xPC 508, such as the positioning center 204 of FIG. 1 and/or the xPC 402 of FIG. 4. The call routers 506 can be implemented as part of the Public Switched Telephone network.

The call routers 506 can be configured to assign a locator key to the emergency services call and determine routing information for the emergency services call. The locator key can be implemented as an Automatic Number Identifier (ANI) (e.g., a standard telephone number), a Pseudo Automatic Number Identifier (pANI), an Emergency Services Routing Key (ESRK), an Emergency Services Query Key (ESQK) any of which can alternatively be generically referred to as an ESxK.

The xPC 508 can be configured to communicate with an ALI service 514. The ALI service 514 can be representative of a plurality of computing devices (e.g., a computing cloud) operating in concert to deploy the ALI service 514. Alternatively, the ALI service 514 can be implemented with a single server. The ALI service 514 can be configured to query the xPC 508 for location information in the manner illustrated and described with respect to FIG. 4.

Upon assigning the locator key, the call routers 506 can forward the emergency services call to the PSAP 504, along with the locator key. The PSAP 504 can include a private branch exchange (PBX) 510 (or other selection router) that can route the emergency services call to an appropriate instance of customer premise equipment (CPE) 512. The CPE 512 can be implemented, for example, as a user terminal. The CPE 512 can be employed by a PSAP operator to establish bi-directional communication with the end-user making the emergency services call, which user can be referred to as a caller. The CPE 512 can output data via a user interface, including the locator key to the operator. Additionally, the operator of the CPE 512 can employ the CPE 512 to provide a location request to an ALI client 517. The ALI client 517 can provide an interface for the ALI service 514. In some examples, the ALI client 517 can be integrated with the ALI service 514, and in other examples, the ALI client 517 and the ALI service 514 can be implemented on separate computing devices that communicate via a network (e.g., the Internet and/or a private network). The location request can include the locator key.

In response to the location request, the ALI client 517 can forward the location request to the ALI service 514. The ALI service 514 can query the xPC 508 for location information (e.g., geographic coordinates, a cell ID of a cell tower communication with the end-user device 502, a street address, etc.). The xPC 508 can return the location information to the ALI service 514, which can be forwarded to the ALI client 517 and to the CPE 512 in response to the original location request. The location information can be output at the CPE 512.

In some examples, an operator of the CPE 512 can determine that the emergency services call needs to be transferred to another entity, such as a third party emergency call service 516. For instance, the operator of the CPE 512 may determine that the end-user device 502 is operating on a waterway (e.g., a boat), such as a waterway emergency services call center (e.g., the U.S. Coast Guard) should handle the call. In this situation the third party emergency call service 516 could be the waterway emergency services call center. In other examples, the operator of the CPE 512 may determine that the end-user device is being used in a campus (e.g., a college campus or business campus) with additional or alternative security. In this situation, the third party emergency call service 516 could be a security desk. In still other examples, there may arise a need for a first responder (e.g., the police, ambulatory service, etc.) to have bi-directional voice communication with the caller employing the end-user device 502. In this situation, the third party emergency call service 516 could be the first responder.

In any of the above noted scenarios, the operator of the CPE 512 can transfer the emergency services call to the third party emergency call service 516. However, to transfer the emergency services call, the operator of the CPE 512 can establish a voice or data bi-directional communication of an operator at the third party emergency call service 516. The third party emergency call service 516 can include a user terminal 518 (e.g., one or more computing devices). In some examples, the third party emergency call service 516 can include hardware similar to the hardware operating at the first responders 102 illustrated in FIG. 1. That is, user terminal 518 of the third party emergency call service 516 can be provided with access to the Internet via TCP/IP. Moreover, the user terminal can include a web browser 520 that accesses the Internet.

To transfer the emergency services call, the operator of the CPE 512 can dial a telephone number associated with the third party emergency call service 516. Upon reaching an operator of the user terminal 518, the operator of the CPE 512 can communicate/provide (e.g., via voice communication or digital communication) the locator key associated with the emergency services call to an operator of the third party emergency call service 516. Additionally, the operator of the user terminal 518 can establish bi-directional communication (e.g., voice or text communication) with the caller employing the end-user device 502.

The operator of the user terminal 518 can employ the web browser 520 to access a web server 522. The web browser 520 can provide a graphical user interface (GUI) to the operator of the user terminal 518 at the third party emergency call service 516. The web server 522 can be implemented, for example, as a web service interface (e.g., a service accessible by a web browser). The web server 522 can be representative of a plurality of computing devices (e.g., a computing cloud) operating in concert to deploy the web server 522. Alternatively, the web server 522 can be implemented with a single server. The web server can provide a web page (e.g., in the Hypertext Markup Language (HTML) format) via the Hypertext Transfer Protocol Secure (HTTPS) to the user terminal 518 that allows an operator (via the web browser 520) to provide the locator key of the emergency services call and issue a location request.

In response to the location request, the web server 522 can convert the location request into a location request that employs a protocol native to the ALI service 514, specifically, the Wireless Emergency Service Protocol E2, which is referred to herein as the “E2 protocol”. The web server 522 can forward the converted location request to the ALI service 514. In response, the ALI service 514 can query the xPC 508 (a position center) for the location information for the end-user device 502. The xPC 508 can return the location information to the ALI service 514, such that the ALI service 514 can return a response to the converted location request (via the E2 protocol) provided by the web server 522. The response to the location information can include the location information of the end-user device 502, such as geographic coordinates, a street address and/or a cell-ID of a cell tower communicating with the end-user device 502, etc.

The web server 522 can convert the location information (provided in the E2 protocol) into a web format (e.g., HTML) that can be provided via HTTPS to the web browser 520 of the user terminal 518. The web browser 520 of the user terminal 518 can output (via the GUI) the location information. In this manner, the operator of the user terminal 518 at the third party emergency call service 516 can access the same (or nearly the same) information that is accessible by the PSAP 504. Additionally, the system 500 requires no changes to hardware and/or software at the PSAP 504.

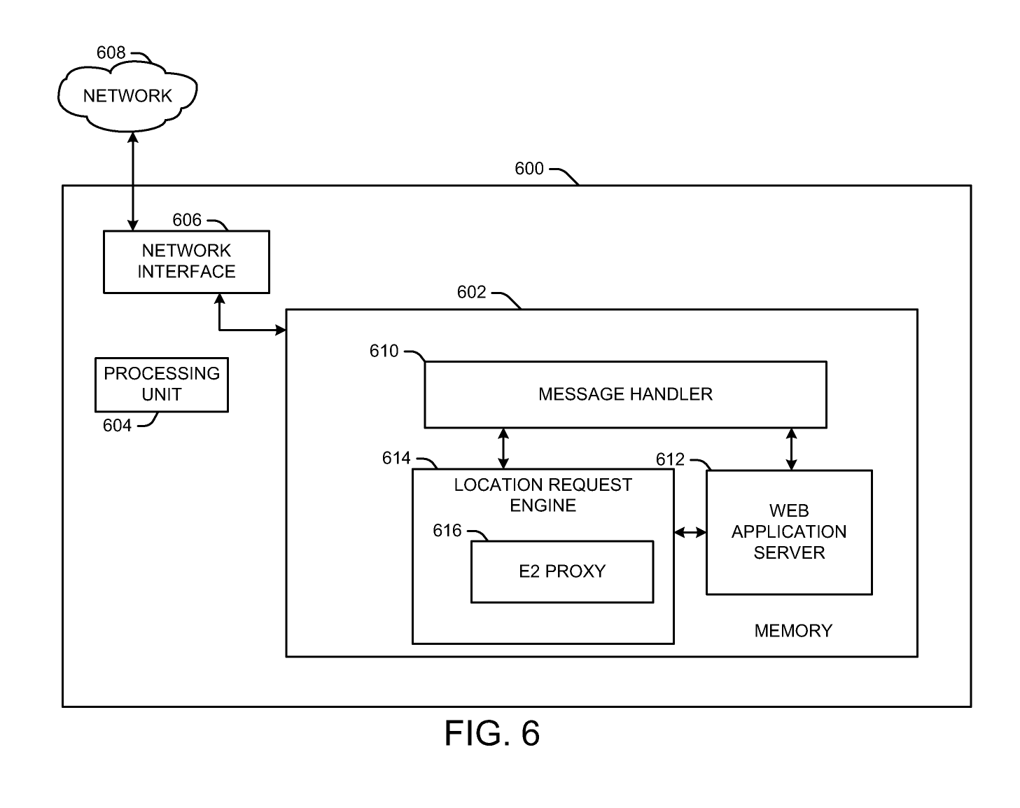

FIG. 6 illustrates an example of a web server 600 that could be employed, for example, as the web server 522 illustrated in FIG. 4. The web server 600 can include a memory 602 that can store machine readable instructions. The memory 602 could be implemented, for example, as non-transitory computer readable media, such as volatile memory (e.g., random access memory), nonvolatile memory (e.g., a hard disk drive, a solid state drive, flash memory, etc.) or a combination thereof. The web server 600 can also include a processing unit 604 to access the memory 602 and execute the machine-readable instructions. The processing unit 604 can include, for example, one or more processor cores. The web server 600 can include a network interface 606 configured to communicate with a network 608. The network interface 606 could be implemented, for example, as a network interface card. The network 608 could be implemented for example, as a public network (e.g., the Internet), a private network (e.g., a carrier network and/or an emergency services telephony network) or combination thereof (e.g., a virtual private network).

The web server 600 could be implemented, for example in a computing cloud. In such a situation, features of the web server 600, such as the processing unit 604, the network interface 606, and the memory 602 could be representative of a single instance of hardware or multiple instances of hardware with applications executing across the multiple of instances (i.e., distributed) of hardware (e.g., computers, routers, memory, processors, or a combination thereof). Alternatively, the web server 600 could be implemented on a single dedicated server.

The memory 602 of the web server 600 can include a message handler 610 that can send and receive network messages via the network interface 606. In some examples, the message handler 610 can receive a request via the HTTPS (or other standard web protocol) protocol to access a web page (e.g., in HTML format) from a web browser operating on a user terminal, such as the user terminal 518 at the third party emergency call service 516 of FIG. 4. The web page access request can be forwarded to a web application server 612 stored in the memory 602. The web application server 612 can interact with the web browser operating on the user terminal. In particular, the web application server 612 can provide web pages to the web browser. The web pages can include an option to enter a locator key for an emergency services call to initiate a location request. The location request can be in the HTML format provided via HTTPS protocol from the user terminal.

In response to the location request, the web application server 612 can forward the location request to a location request engine 614 of the memory 602. The location request engine 614 can be configured as a servlet application that can include an E2 proxy 616 that can convert the location request from the HTML format into messages in a protocol employable by an ALI service, such as the E2 protocol to form a converted location request that includes the locator key. The location request engine 614 can provide the converted location request to the message handler 610.

The message handler 610 can forward the converted location request to an ALI service (e.g., the ALI service 514 of FIG. 4) via the network interface 606 and the network 608. The message handler 610 can receive a response to the location request (in the E2 protocol) from the ALI service. The message handler 610 can forward the response to the location request back to the location request engine 614. The location request engine 614 can employ the E2 proxy 616 to convert the response to the location request into a format employable by the web application server 612 (e.g., the HTML format). The response to the location request can include location information corresponding to an end-user device (e.g., the end-user device 502 of FIG. 5) employed to initiate the emergency services call corresponding to the locator key.

The location information can include, for example, geographic coordinates, a street address and/or a cell-ID of a cell tower communicating with the end-user device. The location information (in the HTML format) can be provided to the web application server 612. The web application server 612 can generate a web page that includes the location information that can be output to the message handler 610. The web page can be output as messages using the HTTPS protocol. The message handler 610 can forward the web page via the HTTPS protocol to the web browser of the user terminal.

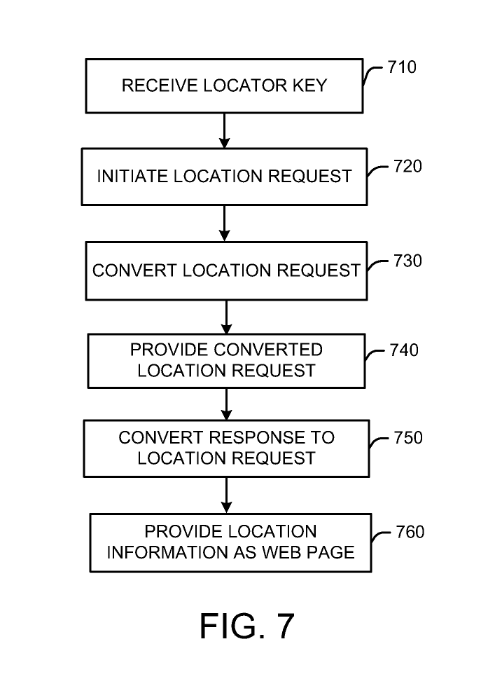

In view of the foregoing structural and functional features described above, example methods will be better appreciated with reference to FIG. 7. While, for purposes of simplicity of explanation, the example method of FIG. 7 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 7 can be implemented as instructions stored in a non-transitory machine-readable medium. The instructions can be accessed by a processing resource (e.g., one or more processor cores) and executed to perform the methods disclosed herein.

FIG. 7 illustrates a flowchart of an example method 700 for providing a web browser interface for an ALI service, such as the ALI service 514 of FIG. 5. The web browser interface can be a web page accessible by a web browser operating at a third party emergency call service, such as the third party emergency call service 516 of FIG. 5. The method 700 can be implemented by a web server, such as the web server 522 of FIG. 5 and/or the web server 600 of FIG. 6.

At 710, a locator key corresponding to an emergency services call can be received at the web server from the user terminal in response to user input. The emergency services call can be initiated by an end-user device (e.g., the end-user device 502 of FIG. 5) that has been transferred from a PSAP (e.g., the PSAP 504 of FIG. 5). The locator key can be received in messages via the HTTPS protocol. At 720, the web server can generate a location request in response to the receipt of the locator key. At 730, the web server can convert the location request into a protocol compatible with the ALI service, such as the E2 protocol to form a converted location request.

At 740, the converted location request can be provided to the ALI service. At 750, a response to the location request (in the E2 protocol) can be converted into the HTML format. The response to the location request can include location information for the end-user device. At 760 the location information can be provided to the web browser of the user terminal as a web page in the HTML format via the HTTPS protocol. In this manner the operator of the user terminal can be provided with the same (or nearly the same) information as operators of the PSAP.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium having machine executable instructions comprising a web server, the web server being configured to:
receive a request for a web page in a standard web protocol from a web browser operating at a third party emergency call service via a network;
receive a locator key corresponding to an emergency services call from an end-user device employed to initiate an emergency services call, wherein the emergency services call is initially routed to a Public Safety Answering Point (PSAP);
provide a location request in a protocol compatible with an Automatic Locator Identifier (ALI) service via the network; and
convert location information for the end-user device provided from the ALI service in response to the location request into a standard web protocol.

2. The medium of claim 1, wherein the standard web protocol is the Hypertext Transfer Protocol Secure (HTTPS) protocol and the protocol compatible with the ALI service is the E2 protocol.

3. The medium of claim 1, wherein the emergency services call is transferred to the third party emergency call service.

4. The medium of claim 1, wherein the location information includes at least one of geographic coordinates, a street address and a cell-ID for a cell tower communicating with the end-user device.

5. The medium of claim 4, wherein the end-user device is a cell phone.

6. The medium of claim 1, wherein the locator key is an Emergency Services Routing Key (ESRK) or an Emergency Services Query Key (ESQK).

7. The medium of claim 1, wherein the locator key is a Pseudo Automatic Number Identifier (pANI).

8. The medium of claim 1, wherein the third party emergency call service is a waterway emergency services call center.

9. A web server comprising:
a non-transitory memory to store machine readable instructions;
a processing unit to access the memory and execute the machine readable instructions, the machine readable instructions comprising:
a web application server configured to:
provide a web interface to a web browser via a standard web protocol, wherein the web browser is operating at a third party emergency call service;
receive a locator key for an emergency services call initiated at an end-user device via the standard web protocol; and
generate a location request that includes the locator key; and
a location request engine configured to:
convert the location request into a protocol employable by an Automatic Location Identification (ALI) service to form a converted location request;
provide the converted location request to the ALI service;
convert location information received from the ALI service into a web format.

10. The web server of claim 9, wherein web application server is further configured to generate a web page that includes the location information.

11. The web server of claim 10, wherein the web format is the Hypertext Markup Language (HTML) format.

12. The web server of claim 9, wherein the protocol employable by the ALI service is the E2 protocol.

13. The web server of claim 12, wherein the standard web protocol is the Hypertext Transfer Protocol Secure (HTTPS) protocol.

14. The web server of claim 9, wherein the emergency services call is routed to a Public Safety Answering Point (PSAP) and transferred to the third party emergency call service.

15. The web server of claim 9, wherein the end-user device is a cell phone.

16. The web server of claim 9, wherein the location information comprises at least one of geographic coordinates, a street address and a cell-ID for a tower communicating with the end-user device.

17. The web server of claim 9, wherein the third party emergency call service is one of a first responder, a waterway emergency service call center and a campus security desk.

18. A method comprising:
receiving, from a user terminal operating at a third party emergency service call center, a locator key corresponding to an emergency services call routed to a Public Safety Answering Point (PSAP), wherein the emergency services call has been transferred to the third party emergency service call center;
converting a location request from a standard web format into a protocol employable by an Automatic Number Identifier (ALI) service; and
converting a response to the location request into the standard web format.

19. The method of claim 18, wherein the protocol employable by the ALI service is the E2 protocol.

20. The method of claim 18, wherein the standard web format is the Hypertext Markup Language (HTML) format.
